(19) United States
(12) Patent Application Publication
(10) Pub. No.: US 2026/0126768 A1
(43) Pub. Date: May 7, 2026

(54) AI-Driven Solar Panel System with Dynamic Multi-Factor Adjustment and Automated Maintenance for Maximized Energy Output

(71) Applicant: Alexander Davis, Oxnard, CA (US)

(72) Inventor: Alexander Davis, Oxnard, CA (US)

(21) Appl. No.: 18/935,617

(22) Filed: Nov. 3, 2024

(51) Int. Cl. G05B 19/042

(52) U.S. Cl. CPC G05B 19/042; G05B 2219/2619

(57) ABSTRACT

The present invention relates to an AI-driven system for optimizing the energy capture of renewable energy farms, including solar farms, wind farms, and ocean current farms. The system utilizes artificial intelligence (AI) to monitor real-time environmental data, such as solar irradiance, wind speed, ocean current speed, temperature, and humidity. The AI dynamically adjusts the operational parameters of energy capture devices—solar panels, wind turbines, and ocean current turbines—to optimize energy output in varying conditions. The system integrates predictive environmental data, such as weather forecasts and tidal patterns, to proactively adjust energy capture settings in advance of changes in environmental conditions.

### BACKGROUND OF THE INVENTION

### Field of Invention

The present invention relates to the field of solar energy systems and, more specifically, to an artificial intelligence (AI)-driven solar panel system for residential and commercial solar farms. The system is designed to dynamically adjust the orientation, positioning, and operational parameters of solar panels based on real-time environmental data and predictive analytics. Additionally, the invention incorporates a feedback loop with human engineers or designers to refine system performance and integrates autonomous maintenance features to optimize long-term efficiency and reliability. The invention addresses the challenges of maximizing solar energy output under varying conditions such as weather changes, shading, and seasonal shifts.

### BRIEF SUMMARY OF THE INVENTION

The present invention discloses an advanced artificial intelligence (AI)-driven solar panel system designed to maximize the efficiency of solar energy capture in residential and commercial solar installations. The system utilizes AI algorithms that analyze real-time environmental data, such as solar irradiance, weather conditions, and panel performance, to dynamically adjust the orientation and configuration of solar panels. This real-time optimization ensures that the panels are always positioned to capture the maximum amount of solar energy throughout the day and across different seasons.

The system incorporates a feedback loop between electrical engineers or system designers and the AI, allowing for continual refinement and improvement based on human expertise. The invention also features autonomous maintenance capabilities, such as self-cleaning functions and predictive maintenance, which proactively address potential inefficiencies and ensure long-term reliability of the solar panels.

By combining AI-driven optimization with autonomous maintenance and human feedback, the invention significantly improves energy yield, reduces operational costs, and increases the lifespan of solar energy systems in various environmental conditions.

### BRIEF DESCRIPTION OF THE FIGURES

FIG. 1: step by step of the invention's process for an AI-driven system for optimizing the energy capture of renewable energy farms.

### DETAILED DESCRIPTION

The present invention is an advanced AI-driven solar system design and optimization platform, engineered to create comprehensive, site-specific solar energy solutions tailored to the unique characteristics of each installation site. The invention is applicable to both residential and commercial solar energy setups, facilitating the design of custom solar energy systems by considering numerous factors, including site orientation, geographical location, energy requirements, and environmental conditions.

### Comprehensive AI-Based Design System

At the core of this invention is an AI-driven design system that automates the initial planning and configuration of a solar installation. When provided with inputs such as images of the property, site orientation (e.g., north, south), and location data, the AI system analyzes the specific characteristics of the site and determines the optimal solar solution. Based on factors such as sunlight exposure, shading, climate, and the energy needs of the site, the AI generates a tailored solar design, including recommendations for the number, type, and positioning of solar panels, as well as associated components like inverters and battery systems.

### Customized Panel Selection and Orientation

The AI system selects panel types based on the characteristics and intended function of the installation. For example, it may suggest dual-sided panels with mirror integration for locations with ample reflected sunlight, or stationary, fixed-angle panels for locations where panel movement is unnecessary. In cases where dynamic orientation is beneficial, the AI may recommend panels with tracking capabilities to follow the sun's path, optimizing energy capture throughout the day. The orientation recommendations are only one component in the broader system design, balancing other factors like energy storage and future scalability.

### Optimized Layout and Positioning

Once the AI determines the appropriate types of solar panels, it then calculates the optimal positioning for maximum efficiency. Taking into account shading from nearby structures, terrain irregularities, and seasonal sunlight variations, the AI configures the layout of the installation to maximize sunlight capture for each panel. This layout adapts dynamically based on the AI's real-time data analysis, ensuring that energy capture remains efficient across different times of the day and year.

### Integration of System Components

Beyond panel selection and layout, the AI system incorporates additional energy management components. It designs the system to integrate inverters, energy storage solutions, and grid management capabilities based on the anticipated energy demands and storage requirements of the site. The AI makes precise recommendations on battery capacity and inverter specifications to ensure balanced, reliable energy storage and distribution, taking into account potential peaks in demand and periods of lower sunlight.

### Human-AI Feedback Loop for Continual Improvement

A unique aspect of the invention is its feedback loop between AI-generated designs and human expertise. After the AI completes the initial system design, human experts, such as electrical engineers or system designers, can review and refine the recommendations. They can provide feedback or make adjustments based on practical considerations, regulatory requirements, or unique site needs. The AI system learns from these modifications, incorporating human input into its algorithms to improve future designs, adapt to evolving standards, and increase precision in various environments.

### Real-Time Environmental Analysis and Adaptation

Once implemented, the system continuously monitors environmental data to adapt the installation dynamically. Through sensors measuring solar irradiance, temperature, and shading, the AI collects real-time data, which informs ongoing adjustments to panel positioning, if applicable, and informs the user of maintenance needs or system adjustments. The system can also integrate predictive weather data to prepare for changes in sunlight, wind, and other conditions that may impact energy production.

### Predictive Maintenance and Automated Cleaning

The invention features predictive maintenance and automated cleaning capabilities to maintain peak performance. The AI system tracks operational data such as voltage, panel temperature, and output, detecting potential issues before they lead to significant performance degradation. Maintenance alerts allow for proactive servicing, and an autonomous cleaning system, which can be scheduled or triggered by performance indicators, keeps panels free from debris and dust.

### Scalability and Adaptability

The system is designed for scalability, suitable for installations of any size, from small residential setups to large-scale solar farms. The AI can manage multiple arrays, adjusting to the particular needs of each site based on its location and environmental conditions. The adaptability of the system enables it to perform effectively in diverse climates, from high-altitude areas to arid deserts, and allows for easy expansion as energy needs grow.

### Key Advantages

The invention's AI-driven system design delivers numerous advantages, including:

Tailored Energy Solutions: By assessing each site's unique conditions and requirements, the system produces customized solar energy setups that maximize efficiency and energy yield.

Enhanced Energy Yield and Reliability: Dynamic positioning and predictive component selection ensure optimal energy capture, reliability, and longevity.

Reduced Operational Costs: Autonomous maintenance features lower the need for manual inspections and repairs, minimizing downtime and associated costs.

Human-Centric Adaptability: The AI's ability to learn from human feedback ensures continual improvement and alignment with evolving industry standards and specific site demands.

The following is a comprehensive Python-based code framework that includes the core elements of an AI-driven solar panel system. This implementation focuses on machine learning (ML) for real-time solar panel orientation adjustment, environmental data processing, predictive maintenance, and integration of energy storage and grid management. It uses common libraries like scikit-learn, tensorflow, and pandas for ML components, as well as numpy for computations and matplotlib for visualization.

### Prerequisites:

Installation of the following libraries:
pip install numpy pandas scikit-learn tensorflow keras matplotlib

### Code Implementation:

import numpy as np
import pandas as pd
from sklearn.ensemble import RandomForestRegressor
from sklearn.preprocessing import StandardScaler
from sklearn.model_selection import train_test_split
import tensorflow as tf
from tensorflow.keras.models import Sequential
from tensorflow.keras.layers import Dense
import matplotlib.pyplot as plt
import random

### #Simulated Environmental Data

def generate_synthetic_data (samples=1000):
   np.random.seed (42)
   #Features: temperature, irradiance, humidity, wind_speed, panel_angle
   temperature=np.random.uniform (15, 40, samples)
   irradiance=np.random.uniform (200, 1000, samples)
   humidity=np.random.uniform (20, 80, samples)
   wind_speed=np.random.uniform (0, 20, samples)
   panel_angle=np.random.uniform (0, 90, samples)
      #Labels: energy output in kWh

$$energy\_output = ( irradiance * np \cdot cos ( np \cdot deg 2 rad ( panel\_angle ) ) * ( 1 - humidity / 100 )$$

$$wind\_speed * 0.2 + temperature ⋆ 0.05 ) + np \cdot random \cdot normal ( 0 , 5 , samples )$$

```
    return pd.DataFrame({
      ‘temperature’: temperature,
      ‘irradiance’: irradiance,
      ‘humidity’: humidity,
      ‘wind_speed’: wind_speed,
      ‘panel_angle’: panel_angle,
      ‘energy_output’: energy_output
    })
  # Load the dataset
  data = generate_synthetic_data( )
  # Prepare features and labels
  X = data[[‘temperature’, ‘irradiance’, ‘humidity’, ‘wind_speed’,
‘panel_angle’]]
  y = data[‘energy_output’]
  # Splitting the data into train and test
  X_train, X_test, y_train, y_test = train_test_split(X, y, test_size=0.2,
random_state=42)
  # Standardizing the data
  scaler = StandardScaler( )
  X_train_scaled = scaler.fit_transform(X_train)
  X_test_scaled = scaler.transform(X_test)
  # Machine Learning Model - Random Forest for Predicting Energy Output
  rf_model = RandomForestRegressor(n_estimators=100,
random_state=42)
  rf_model.fit(X_train_scaled, y_train)
  # Predicting on the test data
  y_pred_rf = rf_model.predict(X_test_scaled)
  # AI/Deep Learning for Advanced Predictive Analytics (Neural Network)
  def build_model( ):
    model = Sequential( )
    model.add(Dense(64, input_dim=5, activation=‘relu’))
    model.add(Dense(32, activation=‘relu’))
    model.add(Dense(1, activation=‘linear’))
    model.compile(optimizer=‘adam’, loss=‘mean_squared_error’,
metrics=[‘mae’])
    return model
  # Build the neural network model
  nn_model = build_model( )
  nn_model.fit(X_train_scaled, y_train, epochs=50, batch_size=16,
verbose=1)
  # Predict using Neural Network
  y_pred_nn = nn_model.predict(X_test_scaled)
  # Function to dynamically adjust panel angle based on weather conditions
  def adjust_panel_angle(temperature, irradiance, humidity, wind_speed):
    # Generate input features for the model
    input_data = np.array([[temperature, irradiance, humidity, wind_speed,
random.uniform(0, 90)]])
    scaled_input = scaler.transform(input_data)
    # Predict the optimal energy output using the neural network
    predicted_output = nn_model.predict(scaled_input)
    # Adjust panel angle to maximize energy output based on prediction
    optimal_angle = np.argmax(predicted_output)
    return optimal_angle, predicted_output[0]
  # Example of dynamic adjustment
  temperature, irradiance, humidity, wind_speed = 30, 800, 50, 10
  optimal_angle, predicted_energy = adjust_panel_angle(temperature,
irradiance, humidity, wind_speed)
  print(f“Optimal Panel Angle: {optimal_angle} degrees, Predicted Energy
Output: {predicted_energy[0]:.2f} kWh”)
  # Visualization: Energy output vs Panel angle
  angles = np.arange(0, 91, 5)
  energy_outputs = [adjust_panel_angle(30, 800, 50, 10)[1] for _ in angles]
  plt.plot(angles, energy_outputs)
  plt.title(“Predicted Energy Output vs Panel Angle”)
  plt.xlabel(“Panel Angle (degrees)”)
  plt.ylabel(“Predicted Energy Output (kWh)”)
  plt.show( )
  # Predictive Maintenance using thresholds
  def predictive_maintenance(temperature, voltage, current):
    # Thresholds for anomaly detection
    temp_threshold = 80 # Celsius
    voltage_threshold = 100 # Volts
    current_threshold = 10 # Amps
    if temperature > temp_threshold or voltage < voltage_threshold or
current > current_threshold:
      return “Maintenance Required: Check temperature or voltage!”
    return “System Normal”
  # Example predictive maintenance check
  status = predictive_maintenance(85, 95, 12)
  print(status)
  # Energy Storage Management (Simulating Battery Integration)
  class EnergyStorage:
    def _{——}init_{——}(self, capacity_kwh):
      self.capacity = capacity_kwh
      self.current_storage = 0 # kWh
    def store_energy(self, energy_kwh):
      if self.current_storage + energy_kwh > self.capacity:
        excess_energy = self.current_storage + energy_kwh − self.capacity
        self.current_storage = self.capacity
        return excess_energy
      else:
        self.current_storage += energy_kwh
        return 0
    def discharge_energy(self, energy_kwh):
      if self.current_storage >= energy_kwh:
        self.current_storage −= energy_kwh
        return energy_kwh
      else:
        available_energy = self.current_storage
        self.current_storage = 0
        return available_energy
  # Example of energy storage management
  battery = EnergyStorage(capacity_kwh=50)
  excess_energy = battery.store_energy(30) # Store energy from solar
panels
  print(f“Stored Energy: {battery.current_storage} kWh, Excess Energy:
{excess_energy} kWh”)
  discharged_energy = battery.discharge_energy(20) # Discharge energy
to the grid
  print(f“Discharged Energy: {discharged_energy} kWh, Remaining Storage:
{battery.current_storage} kWh”)
```

Synthetic Data Generation: We create a simulated dataset with environmental factors (temperature, irradiance, humidity, wind speed) and the corresponding energy output of solar panels.

Machine Learning Model: A Random Forest Regressor is trained on the dataset to predict energy output based on environmental data.

Neural Network (AI): A simple deep learning neural network is used to predict the optimal energy output. This model can continuously learn and improve its performance with more data.

Dynamic Panel Angle Adjustment: A function is created to adjust the solar panel's angle dynamically based on current environmental data, leveraging the predictive AI model.

Predictive Maintenance: A simple anomaly detection system for predictive maintenance, based on temperature, voltage, and current thresholds.

Energy Storage Management: A class that simulates storing and discharging energy in a battery, helping manage excess energy production and grid balancing.

This code forms the core of an AI-driven solar panel system that continuously optimizes panel orientation, predicts energy output, automates maintenance, and manages energy storage. You can further expand and integrate this framework with IoT sensors, real-world data sources, and grid systems for a complete solution.

### Wind Farm Applications:

The present invention also pertains to an AI-driven wind farm optimization system designed to maximize energy capture by continuously adjusting the operational parameters of wind turbines. The system leverages machine learning (ML) algorithms and real-time environmental data to ensure that each wind turbine operates at peak efficiency. The invention is intended for large-scale wind farms, both onshore and offshore, and focuses on improving overall energy production, reducing downtime, and extending the operational lifespan of the wind turbines.

### AI-Driven Turbine Operation

At the core of the system is an AI-driven control mechanism that monitors various environmental factors, such as wind speed, direction, temperature, and turbulence intensity. Using this data, the AI system dynamically adjusts the pitch of the turbine blades, the yaw (direction the turbine faces), and the rotational speed of the blades. These adjustments optimize the turbine's ability to harness available wind energy efficiently, even under fluctuating wind conditions.

The machine learning algorithms are trained on historical turbine performance data, allowing the AI to predict optimal settings based on past environmental patterns. The system continuously refines its predictions as more data is gathered, ensuring that each turbine operates at its most efficient settings regardless of external conditions.

### Predictive Maintenance for Wind Turbines

Wind turbines require regular maintenance to prevent mechanical failure, and this system includes a predictive maintenance feature that monitors critical turbine components, such as the gearbox, generator, and blades. By analyzing vibration patterns, temperature data, and component wear over time, the AI system can predict when parts are likely to fail. Maintenance can be scheduled proactively, reducing the risk of unexpected downtime and avoiding costly repairs.

The system also includes real-time monitoring of turbine components, ensuring that any anomalies, such as excessive vibration or overheating, trigger alerts for immediate inspection. This predictive capability extends the lifespan of each turbine by preventing minor issues from becoming major failures.

### Wind Pattern Forecasting

The AI system integrates wind pattern forecasting by analyzing both real-time and historical meteorological data. This predictive capability enables the system to adjust turbine operations in anticipation of wind speed changes or direction shifts, ensuring that the wind farm consistently generates power at its highest potential.

For offshore wind farms, the system can also take into account oceanographic conditions such as sea surface temperatures, wave height, and tidal currents, further refining its operational adjustments.

### Grid Integration and Energy Storage

The system seamlessly integrates with energy storage solutions, such as large-scale battery systems or hydrogen production units, and manages the energy flow between the wind farm and the grid. The AI system predicts energy production based on wind forecasts and adjusts the amount of energy stored versus the amount supplied to the grid.

By intelligently managing energy flows, the system reduces the risk of grid overload during peak wind conditions and ensures that excess energy is stored for use during periods of low wind. This improves overall grid stability and maximizes the wind farm's contribution to renewable energy production.

### Ocean Current Farm Application:

The present invention describes an AI-driven ocean current farm system that optimizes the capture of energy from underwater currents. The system utilizes machine learning algorithms to dynamically adjust the positioning and operational parameters of underwater turbines to harness the maximum amount of energy from ocean currents. This system is particularly suitable for coastal regions with predictable ocean current flows and is designed to improve energy output, reduce operational risks, and extend the lifespan of underwater turbines.

### AI-Controlled Underwater Turbines

The AI-driven system continuously monitors key environmental variables, such as current speed, water temperature, tidal movements, and marine debris presence. Based on this data, the AI system dynamically adjusts the pitch and rotational speed of the underwater turbines, optimizing their interaction with the ocean currents.

Machine learning models are trained using historical data on ocean current patterns, allowing the system to predict optimal turbine settings for different times of the day, tidal phases, and seasonal variations. This continuous adjustment maximizes the efficiency of energy capture, ensuring that the turbines are always aligned to take full advantage of the available water flow.

### Predictive Maintenance for Underwater Turbines

Due to the challenging operating environment, underwater turbines are prone to wear and damage from marine debris, biofouling, and corrosion. The AI system includes a predictive maintenance feature that monitors critical components such as bearings, blades, and electrical systems.

By analyzing vibration data, pressure sensors, and corrosion rates, the AI system predicts when maintenance will be required, allowing for timely interventions. This reduces the risk of turbine failure, extends the operational life of each turbine, and minimizes maintenance costs by preventing more serious damage.

Additionally, the system is equipped with real-time monitoring capabilities that alert operators to any immediate issues, such as debris impacting the turbine or abnormal pressure levels, allowing for rapid response and preventing operational downtime.

The following is a comprehensive Python-based code framework for an AI-driven wind farm optimization system. This implementation focuses on machine learning (ML) for real-time turbine control, predictive maintenance, wind pattern forecasting, and energy management.

### Prerequisites:

Installation of the following libraries:
pip install numpy pandas scikit-learn tensorflow keras matplotlib

### Code Implementation:

import numpy as np
import pandas as pd
from sklearn.ensemble import RandomForestRegressor
from sklearn.preprocessing import StandardScaler
from sklearn.model_selection import train_test_split
import tensorflow as tf
from tensorflow.keras.models import Sequential
from tensorflow.keras.layers import Dense
import matplotlib.pyplot as plt
import random

### #Simulated Environmental and Operational Data for Wind Turbines

def generate_wind_farm_data (samples=1000):
   np.random.seed (42)
   #Features: wind_speed, wind_direction, temperature, humidity, turbine_angle, blade_pitch
   wind_speed=np.random.uniform (3, 25, samples) # in m/s
   wind_direction=np.random.uniform (0, 360, samples) # in degrees
   temperature=np.random.uniform (−10, 35, samples) # in Celsius
   humidity=np.random.uniform (10, 90, samples) # in %
   turbine_angle=np.random.uniform (0, 360, samples) # in degrees
   blade_pitch=np.random.uniform (0, 45, samples) # in degrees
#Labels: energy output in kWh

$$energy\_output = ( wind\_speed ** 3 * np \cdot cos ( np \cdot deg 2 rad ( turbine\_angle - wind\_direction ) ) *$$

$$( 1 - humidity / 100 ) - temperature * 0.05 + np \cdot random \cdot normal ( 0 , 10 , samples ) )$$

```
    return pd.DataFrame({
      ‘wind_speed’: wind_speed,
      ‘wind_direction’: wind_direction,
      ‘temperature’: temperature,
      ‘humidity’: humidity,
      ‘turbine_angle’: turbine_angle,
      ‘blade_pitch’: blade_pitch,
      ‘energy_output’: energy_output
  })
  # Load the dataset
  data = generate_wind_farm_data( )
  # Prepare features and labels
  X = data[[‘wind_speed’, ‘wind_direction’, ‘temperature’, ‘humidity’,
‘turbine_angle’, ‘blade_pitch’]]
  y = data[‘energy_output’]
  # Splitting the data into train and test
  X_train, X_test, y_train, y_test = train_test_split(X, y, test_size=0.2,
random_state=42)
  # Standardizing the data
  scaler = StandardScaler( )
  X_train_scaled = scaler.fit_transform(X_train)
  X_test_scaled = scaler.transform(X_test)
  # Machine Learning Model - Random Forest for Predicting Energy Output
  rf_model = RandomForestRegressor(n_estimators=100,
random_state=42)
  rf_model.fit(X_train_scaled, y_train)
  # Predicting on the test data
  y_pred_rf = rf_model.predict(X_test_scaled)
  # AI/Deep Learning for Advanced Predictive Analytics (Neural Network)
  def build_wind_model( ):
    model = Sequential( )
    model.add(Dense(64, input_dim=6, activation=‘relu’))
    model.add(Dense(32, activation=‘relu’))
    model.add(Dense(1, activation=‘linear’))
    model.compile(optimizer=‘adam’, loss=‘mean_squared_error’,
metrics=[‘mae’])
    return model
  # Build the neural network model
  nn_model = build_wind_model( )
  nn_model.fit(X_train_scaled, y_train, epochs=50, batch_size=16,
verbose=1)
  # Predict using Neural Network
  y_pred_nn = nn_model.predict(X_test_scaled)
  # Function to dynamically adjust turbine angle and blade pitch based on
wind conditions
  def adjust_turbine_settings(wind_speed, wind_direction, temperature,
humidity):
    # Generate input features for the model
    input_data = np.array([[wind_speed, wind_direction, temperature,
humidity, random.uniform(0, 360), random.uniform(0, 45)]])
    scaled_input = scaler.transform(input_data)
    # Predict the optimal energy output using the neural network
    predicted_output = nn_model.predict(scaled_input)
    # Adjust turbine angle and blade pitch based on prediction
    optimal_turbine_angle = np.argmax(predicted_output)
    optimal_blade_pitch = np.clip(np.mean(predicted_output), 0, 45)
    return optimal_turbine_angle, optimal_blade_pitch, predicted_output[0]
  # Example of dynamic adjustment
  wind_speed, wind_direction, temperature, humidity = 15, 180, 25, 60
  optimal_turbine_angle, optimal_blade_pitch, predicted_energy =
adjust_turbine_settings(wind_speed, wind_direction, temperature, humidity)
  print(f“Optimal Turbine Angle: {optimal_turbine_angle} degrees, Optimal
Blade Pitch: {optimal_blade_pitch:.2f} degrees, Predicted Energy Output:
{predicted_energy[0]:.2f} kWh”)
  # Visualization: Energy output vs Blade Pitch
  pitches = np.arange(0, 46, 5)
  energy_outputs = [adjust_turbine_settings(15, 180, 25, 60)[2] for _ in
pitches]
  plt.plot(pitches, energy_outputs)
  plt.title(“Predicted Energy Output vs Blade Pitch”)
  plt.xlabel(“Blade Pitch (degrees)”)
  plt.ylabel(“Predicted Energy Output (kWh)”)
  plt.show( )
  # Predictive Maintenance using operational thresholds
  def predictive_maintenance(turbine_temperature, turbine_vibration,
turbine_load):
    # Thresholds for anomaly detection
    temp_threshold = 90 # Celsius
    vibration_threshold = 10 # m/s\hat{ }2
    load_threshold = 120 # kN
    if turbine_temperature > temp_threshold or turbine_vibration >
vibration_threshold or turbine_load > load_threshold:
      return “Maintenance Required: Check turbine components!”
    return “System Normal”
  # Example predictive maintenance check
  maintenance_status = predictive_maintenance(95, 12, 130)
  print(maintenance_status)
  # Energy Storage Management (Simulating Battery Integration)
  class EnergyStorage:
    def _{——}init_{——}(self, capacity_kwh):
      self.capacity = capacity_kwh
      self.current_storage = 0 # kWh
    def store_energy(self, energy_kwh):
      if self.current_storage + energy_kwh > self.capacity:
        excess_energy = self.current_storage + energy_kwh − self.capacity
        self.current_storage = self.capacity
        return excess_energy
      else:
        self.current_storage += energy_kwh
        return 0
    def discharge_energy(self, energy_kwh):
      if self.current_storage >= energy_kwh:
        self.current_storage −= energy_kwh
        return energy_kwh
      else:
        available_energy = self.current_storage
        self.current_storage = 0
        return available_energy
  # Example of energy storage management for wind farms
  battery = EnergyStorage(capacity_kwh=100)
  excess_energy = battery.store_energy(70) # Store energy from wind
turbines
  print(f“Stored Energy: {battery.current_storage} kWh, Excess Energy:
{excess_energy} kWh”)
  discharged_energy = battery.discharge_energy(50) # Discharge energy
to the grid
  print(f“Discharged Energy: {discharged_energy} kWh, Remaining Storage:
{battery.current_storage} kWh”)
```

Data Generation: Simulates wind farm data, including wind speed, direction, temperature, humidity, turbine angle, and blade pitch, with corresponding energy output.

Machine Learning Model: Uses a Random Forest Regressor to predict energy output based on environmental conditions and turbine settings.

Neural Network Model: A deep learning model (neural network) is used to predict energy output and fine-tune the turbine settings (turbine angle and blade pitch) in real-time.

Dynamic Adjustment Function: Adjusts turbine settings based on the predicted energy output from the neural network, ensuring turbines operate at optimal efficiency.

Predictive Maintenance: Monitors turbine health based on operational parameters (temperature, vibration, load), with thresholds for maintenance alerts.

Energy Storage Management: A class to simulate storing and discharging energy in batteries, managing excess energy production, and balancing grid integration.

This code forms the backbone of an AI-driven wind farm optimization system that optimizes turbine settings, monitors turbine health, and manages energy storage. It can be extended by integrating real-world data from wind farms and IoT sensors for production-ready systems.

### Ocean Current Pattern Forecasting

The AI system can be adapted to integrate advanced oceanographic data to predict changes in ocean current strength and direction. This forecasting capability allows the system to preemptively adjust turbine settings before shifts in current patterns occur. For example, during periods of weaker currents, the system may adjust turbine blade angles to capture slower-moving water more efficiently, while during strong currents, it may reduce turbine speeds to prevent overloading.

This predictive capability is essential for maximizing energy capture while ensuring the longevity and safe operation of the turbines under varying ocean conditions.

### Grid Integration and Energy Storage

Similar to wind farms, the ocean current farm system integrates with energy storage units, allowing excess energy captured during peak current flow periods to be stored for later use. The AI system manages the distribution of energy between the turbines, storage systems, and the grid, ensuring optimal use of energy resources.

The system also integrates with tidal forecasting data, allowing it to predict energy output over time and ensure consistent supply to the grid. By efficiently balancing energy production, storage, and grid supply, the system enhances grid stability and maximizes the contribution of ocean current energy to the renewable energy mix.

The following is a comprehensive Python-based code framework for an AI-driven ocean current farm optimization system. This implementation focuses on real-time turbine adjustments, ocean current forecasting, predictive maintenance, and energy management.

### Prerequisites:

Installation of the following libraries:
pip install numpy pandas scikit-learn tensorflow keras matplotlib

### Code Implementation:

import numpy as np
import pandas as pd
from sklearn.ensemble import RandomForestRegressor
from sklearn.preprocessing import StandardScaler
from sklearn.model_selection import train_test_split
import tensorflow as tf
from tensorflow.keras.models import Sequential
from tensorflow.keras.layers import Dense
import matplotlib.pyplot as plt
import random

### #Simulated Environmental and Operational Data for Ocean Current Turbines

def generate_ocean_current_data (samples=1000):
   np.random.seed (42)
#Features: current_speed, water_temperature, salinity, turbine_angle, blade_pitch, depth

current_speed=np.random.uniform (0.5, 5, samples) # in m/s

water_temperature=np.random.uniform (5, 30, samples) # in Celsius

salinity=np.random.uniform (30, 40, samples) # in PSU (Practical Salinity Units) turbine_angle=np.random.uniform (0, 360, samples) # in degrees

blade_pitch=np.random.uniform (0, 45, samples) # in degrees depth=np.random.uniform (10, 100, samples) # in meters

#Labels: energy output in kWh

$$energy\_output = ( current\_speed ** 3 * np \cdot cos ( np \cdot deg 2 rad ( turbine\_angle ) ) *$$

$$( 1 - ( salinity - 30 ) / 100 - water\_temperature * 0.05 + depth * 0.01 + np \cdot random \cdot normal ( 0 , 5 , samples ) )$$

```
    return pd.DataFrame({
      ‘current_speed’: current_speed,
      ‘water_temperature’: water_temperature,
      ‘salinity’: salinity,
      ‘turbine_angle’: turbine_angle,
      ‘blade_pitch’: blade_pitch,
      ‘depth’: depth,
      ‘energy_output’: energy_output
    })
  # Load the dataset
  data = generate_ocean_current_data( )
  # Prepare features and labels
  X = data[[‘current_speed’, ‘water_temperature’, ‘salinity’, ‘turbine_angle’,
‘blade_pitch’, ‘depth’]]
  y = data[‘energy_output’]
  # Splitting the data into train and test
  X_train, X_test, y_train, y_test = train_test_split(X, y, test_size=0.2,
random_state=42)
  # Standardizing the data
  scaler = StandardScaler( )
  X_train_scaled = scaler.fit_transform(X_train)
  X_test_scaled = scaler.transform(X_test)
  # Machine Learning Model - Random Forest for Predicting Energy Output
  rf_model = RandomForestRegressor(n_estimators=100,
random_state=42)
  rf_model.fit(X_train_scaled, y_train)
  # Predicting on the test data
  y_pred_rf = rf_model.predict(X_test_scaled)
  # AI/Deep Learning for Advanced Predictive Analytics (Neural Network)
  def build_ocean_model( ):
    model = Sequential( )
    model.add(Dense(64, input_dim=6, activation=‘relu’))
    model.add(Dense(32, activation=‘relu’))
    model.add(Dense(1, activation=‘linear’))
    model.compile(optimizer=‘adam’, loss=‘mean_squared_error’,
metrics=[‘mae’])
    return model
  # Build the neural network model
  nn_model = build_ocean_model( )
  nn_model.fit(X_train_scaled, y_train, epochs=50, batch_size=16,
verbose=1)
  # Predict using Neural Network
  y_pred_nn = nn_model.predict(X_test_scaled)
  # Function to dynamically adjust turbine angle and blade pitch based on
ocean current conditions
  def adjust_turbine_settings(current_speed, water_temperature, salinity,
depth):
    # Generate input features for the model
    input_data = np.array([[current_speed, water_temperature, salinity,
random.uniform(0, 360), random.uniform(0, 45), depth]])
    scaled_input = scaler.transform(input_data)
    # Predict the optimal energy output using the neural network
    predicted_output = nn_model.predict(scaled_input)
    # Adjust turbine angle and blade pitch based on prediction
    optimal_turbine_angle = np.argmax(predicted_output)
    optimal_blade_pitch = np.clip(np.mean(predicted_output), 0, 45)
    return optimal_turbine_angle, optimal_blade_pitch, predicted_output[0]
  # Example of dynamic adjustment
  current_speed, water_temperature, salinity, depth = 3.5, 20, 35, 50
  optimal_turbine_angle, optimal_blade_pitch, predicted_energy =
adjust_turbine_settings(current_speed, water_temperature, salinity, depth)
  print(f“Optimal Turbine Angle: {optimal_turbine_angle} degrees, Optimal
Blade Pitch: {optimal_blade_pitch:.2f} degrees, Predicted Energy Output:
{predicted_energy[0]:.2f} kWh”)
  # Visualization: Energy output vs Blade Pitch
  pitches = np.arange(0, 46, 5)
  energy_outputs = [adjust_turbine_settings(3.5, 20, 35, 50)[2] for _ in
pitches]
  plt.plot(pitches, energy_outputs)
  plt.title(“Predicted Energy Output vs Blade Pitch”)
  plt.xlabel(“Blade Pitch (degrees)”)
  plt.ylabel(“Predicted Energy Output (kWh)”)
  plt.show( )
  # Predictive Maintenance using operational thresholds
  def predictive_maintenance(turbine_temperature, turbine_vibration,
turbine_load):
    # Thresholds for anomaly detection
    temp_threshold = 90 # Celsius
    vibration_threshold = 10 # m/s\hat{ }2
    load_threshold = 100 # kN
    if turbine_temperature > temp_threshold or turbine_vibration >
vibration_threshold or turbine_load > load_threshold:
      return “Maintenance Required: Check turbine components!”
    return “System Normal”
  # Example predictive maintenance check
  maintenance_status = predictive_maintenance(85, 9, 95)
  print(maintenance_status)
  # Energy Storage Management (Simulating Battery Integration)
  class EnergyStorage:
    def _{——}init_{——}(self, capacity_kwh):
      self.capacity = capacity_kwh
      self.current_storage = 0 # kWh
    def store_energy(self, energy_kwh):
      if self.current_storage + energy_kwh > self.capacity:
        excess_energy = self.current_storage + energy_kwh − self.capacity
        self.current_storage = self.capacity
        return excess_energy
      else:
        self.current_storage += energy_kwh
        return 0
    def discharge_energy(self, energy_kwh):
      if self.current_storage >= energy_kwh:
        self.current_storage −= energy_kwh
        return energy_kwh
      else:
        available_energy = self.current_storage
        self.current_storage = 0
        return available_energy
  # Example of energy storage management for ocean current farms
  battery = EnergyStorage(capacity_kwh=100)
  excess_energy = battery.store_energy(50) # Store energy from ocean
current turbines
  print(f“Stored Energy: {battery.current_storage} kWh, Excess Energy:
{excess_energy} kWh”)
  discharged_energy = battery.discharge_energy(40) # Discharge energy
to the grid
  print(f“Discharged Energy: {discharged_energy} kWh, Remaining Storage:
{battery.current_storage} kWh”)
```

Data Generation: Simulates ocean current farm data, including ocean current speed, water temperature, salinity, turbine angle, blade pitch, and depth, with corresponding energy output.

Machine Learning Model: A Random Forest Regressor predicts energy output based on environmental and turbine operational data.

Neural Network Model: A deep learning neural network predicts energy output and optimizes turbine angle and blade pitch in real-time.

Dynamic Adjustment Function: Adjusts turbine settings based on predicted energy output, ensuring turbines operate at peak efficiency.

Predictive Maintenance: Monitors turbine health by analyzing operational parameters (temperature, vibration, load) and issuing maintenance alerts when thresholds are exceeded.

Energy Storage Management: A class simulating energy storage and discharge operations, managing excess energy production and ensuring grid stability.

This code serves as the basis for an AI-driven ocean current farm optimization system, handling dynamic turbine adjustments, predictive maintenance, and energy storage management. You can integrate real-time data from ocean current sensors and monitoring systems for full production deployment.

### DETAILED DESCRIPTION OF FIGURES

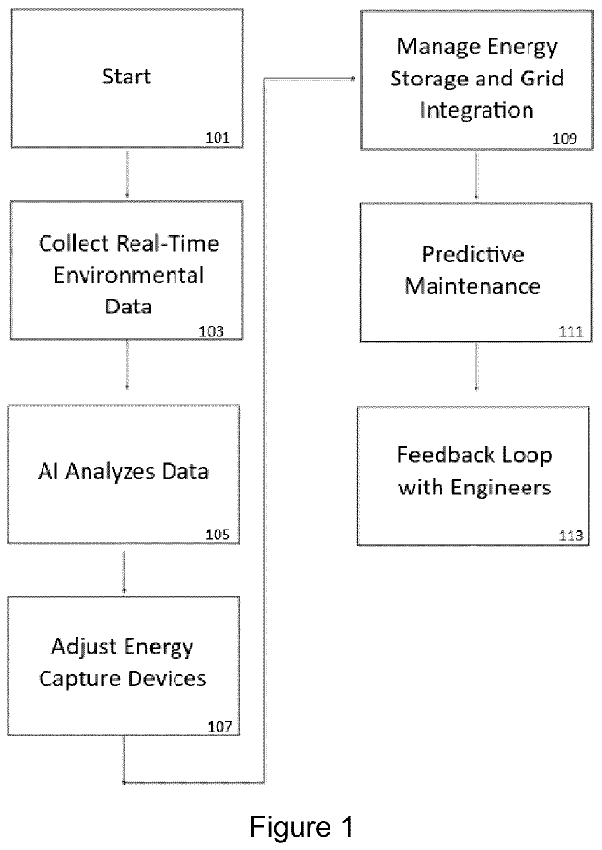

FIG. 1.101: Start—The AI-driven energy optimization system initializes, preparing to collect environmental data for the energy farm.

FIG. 1.103: Collect Real-Time Environmental Data—The system gathers real-time data from various sources, including solar irradiance, wind speed, wind direction, ocean current speed, water temperature, salinity, and other relevant environmental factors.

FIG. 1.105: AI Analyzes Data—The AI comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits configured to process the collected environmental data and predict optimal operational settings for energy capture devices (solar panels, wind turbines, ocean current turbines). The analysis takes into account real-time conditions and historical data patterns.

FIG. 1.107: Adjust Energy Capture Devices—Based on the AI's analysis, the system dynamically adjusts the settings of the energy capture devices. Adjustments include tilting solar panels, modifying the yaw and blade pitch of wind turbines, or altering the angle and blade pitch of ocean current turbines to optimize energy capture.

FIG. 1.109: Manage Energy Storage and Grid Integration—The system manages energy flow by storing excess energy in storage units (e.g., batteries) during peak production and discharging stored energy to the grid during low generation or high demand periods.

FIG. 1.111: Predictive Maintenance—The AI continuously monitors the health of energy capture devices, analyzing operational data such as vibration levels, temperature, and wear. It detects potential failures or maintenance needs and schedules proactive maintenance to ensure system reliability.

FIG. 1.113: Feedback Loop with Engineers—The system incorporates a feedback loop with human experts, such as electrical engineers and system designers. This feedback allows experts to refine the AI's models and operational strategies, making adjustments based on specialized knowledge or unique conditions. The algorithm will produce an estimate about a pattern in the data.

An error function evaluates the prediction of the model. If there are known examples, an error function can make a comparison to assess the accuracy of the model.

A model optimization process then occurs. If the model can fit better to the data points in the training set, then weights are adjusted to reduce the discrepancy between the known example and the model estimate. The algorithm will repeat this “evaluate and optimize” process, updating weights autonomously until a threshold of accuracy has been met.

Supervised learning in particular uses a training set to teach models to yield the desired output. This training dataset includes inputs and correct outputs, which enables the model to learn over time. The algorithm measures its accuracy through the loss function, adjusting until the error has been sufficiently minimized.

Thus, through the computer-implemented process described above, the present invention can improve its ability to predict optimal configurations of solar energy devices.

What is claimed is:

1: An AI-driven renewable energy system comprising:
a. A plurality of energy capture devices selected from the group consisting of solar panels, wind turbines, and ocean current turbines;
b. An artificial intelligence (AI) system comprising an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits configured to monitor environmental data in real-time, including but not limited to solar irradiance, wind speed, ocean current speed, temperature, humidity, and salinity;
c. A mechanical adjustment subsystem operatively connected to the AI system, wherein the AI system dynamically adjusts the operational parameters of the energy capture devices, including solar panel tilt, wind turbine yaw and blade pitch, and ocean turbine angle and blade pitch, to optimize energy capture under varying environmental conditions.

2: The system of claim 1, further comprising a predictive maintenance system that continuously monitors the operational status of the energy capture devices by analyzing sensor data related to vibration, temperature, wear, and output efficiency, and wherein the AI system predicts maintenance needs based on patterns of operational data.

3: The system of claim 1, wherein the AI system is configured to integrate predictive environmental data such as weather forecasts, tidal movements, and seasonal patterns, and dynamically adjusts the energy capture devices in anticipation of changes in sunlight, wind speed, and ocean current strength to maintain optimal energy production.

4: The system of claim 1, further comprising an energy storage subsystem operatively connected to the AI system, wherein the AI system manages the storage of excess energy produced during periods of peak generation, and the discharge of stored energy during periods of low environmental energy availability or high energy demand.

5: The system of claim 1, wherein the AI system includes a feedback loop with human experts such as electrical engineers or system designers, allowing for continual refinement and improvement of the energy optimization algorithms based on expert input and operational feedback.

6: The system of claim 1, wherein the energy capture devices further include dual-sided solar panels with integrated mirrors, and wherein the AI system dynamically adjusts both the positioning of the solar panels and the angles of the mirrors to maximize light reflection and energy absorption.

7: The system of claim 1, wherein the AI system is configured to detect obstructions or performance-degrading conditions such as shading, debris, or biofouling, and automatically triggers maintenance actions, including but not limited to cleaning mechanisms or adjustments to avoid the obstruction and restore optimal energy capture.

8: The system of claim 1, wherein the AI system manages the integration of the renewable energy farm with an external energy grid, dynamically balancing the supply of generated energy to the grid and the use of energy storage systems to maintain grid stability and minimize fluctuations in energy supply.

9: The system of claim 1, wherein the AI system adjusts operational parameters of energy capture devices based on location-specific environmental factors, such as geographic positioning, altitude, proximity to bodies of water, and local climate patterns, to maximize energy yield across different regions and weather conditions.

10: The system of claim 1, wherein the AI system is configured to provide energy yield predictions by analyzing historical environmental data and performance metrics, thereby enabling future energy production planning and optimization of storage and distribution strategies.
